(19) United States
(12) Patent Application Publication
(10) Pub. No.: US 2026/0147663 A1
(43) Pub. Date: May 28, 2026

(54) System and Method for Agentic Artificial Intelligence-Based Site Reliability Engineering

(71) Applicant: Cameron Immesoete, Orinda, CA (US)

(72) Inventor: Cameron Immesoete, Orinda, CA (US)

(21) Appl. No.: 18/957,790

(22) Filed: Nov. 24, 2024

(51) Int. Cl. G06F 11/07; G06F 21/62

(52) U.S. Cl. CPC G06F 11/0793; G06F 21/62

(57) ABSTRACT

Implementations described herein relate to systems, methods, and computer-readable media for autonomous site reliability engineering (SRE) using agentic artificial intelligence (AI). An autonomous SRE agent monitors telemetry associated with one or more software applications, detects anomalies and performance degradations, diagnoses likely causes using artificial intelligence models and/or rules, and selects and executes corrective actions through system interfaces including application programming interfaces (APIs) and, in some implementations, graphical user interface (GUI) automation. Example corrective actions include scaling resources, initiating deployments, initiating rollbacks, performing garbage collection, and rebooting systems. In some implementations, the agent generates code changes and submits pull requests (PRs) for issues for which a matching remediation playbook is unavailable. In some implementations, a policy evaluation engine, access controls, and audit logging are used to constrain and record autonomous actions. The disclosed systems improve resilience and reduce downtime by automating SRE operations with continuous monitoring and rapid response.

### TECHNICAL FIELD

Embodiments relate generally to site reliability engineering, software operations, and artificial intelligence. More particularly, embodiments relate to methods, systems, and computer-readable media for automated, agentic Al-driven site reliability engineering tasks including telemetry monitoring, anomaly detection, issue diagnosis, corrective action selection, and autonomous or semi-autonomous execution of corrective actions in software application environments including cloud, on-premise, and hybrid computing environments.

### BACKGROUND

Site reliability engineering (SRE) commonly involves monitoring software systems, diagnosing incidents, and executing corrective actions to maintain availability, performance, and reliability. In many environments, SRE functions are performed primarily by human operators using monitoring dashboards, alerting systems, deployment tools, infrastructure control planes, and service-specific administrative interfaces.

Human SRE workflows can be effective but may be limited by response latency, operator availability, and operational complexity. For example, an SRE may need to inspect telemetry, identify likely causes of a failure or bottleneck, select a remediation, execute one or more operational changes, verify results, and document the actions taken. These steps may involve multiple systems and interfaces, including APIs, configuration tools, deployment consoles, and source-control systems.

There is a need for improved systems that can continuously monitor software application telemetry, detect abnormal conditions, diagnose issues, and perform one or more corrective actions with reduced delay. There is also a need for systems that can operate within defined access controls and operational policies while recording actions for oversight and auditing.

### SUMMARY

The present disclosure provides systems and methods for agentic Al-based site reliability engineering.

In one aspect, a computer-implemented method is provided in which an autonomous site reliability engineering agent (also referred to herein as an “SRE agent” or “agentic AI SRE agent”) monitors telemetry data associated with one or more software applications in a production computing environment, detects anomalies or performance issues, analyzes the telemetry data to diagnose one or more likely system issues, and performs corrective actions through one or more system interfaces.

In some implementations, the corrective actions include one or more of:
scaling compute or service resources,
initiating a deployment,
initiating a rollback,
performing garbage collection,
restarting or rebooting a service or system component, and/or
modifying configuration values.

In some implementations, the SRE agent interacts with system interfaces through an interface adapter layer that supports API invocation and GUI automation.

In some implementations, the SRE agent prioritizes tasks based on system criticality and service level objectives (SLOs).

In some implementations, the SRE agent uses machine learning models trained on historical telemetry, incident records, and prior remediation actions to improve diagnosis and action selection.

In some implementations, the SRE agent executes actions only after policy evaluation and access-control checks, and records an audit trail of proposed and executed actions.

In some implementations, the SRE agent generates code changes and submits a pull request for an issue condition for which a matching remediation playbook is unavailable.

In some implementations, the SRE agent simulates a proposed corrective action in a sandbox environment before applying the corrective action to a production computing environment.

These and other embodiments are described in greater detail below.

### BRIEF DESCRIPTION OF THE DRAWINGS

FIG. 1 is a system architecture diagram illustrating example components and interactions of an agentic Al-based SRE system and a software application environment.

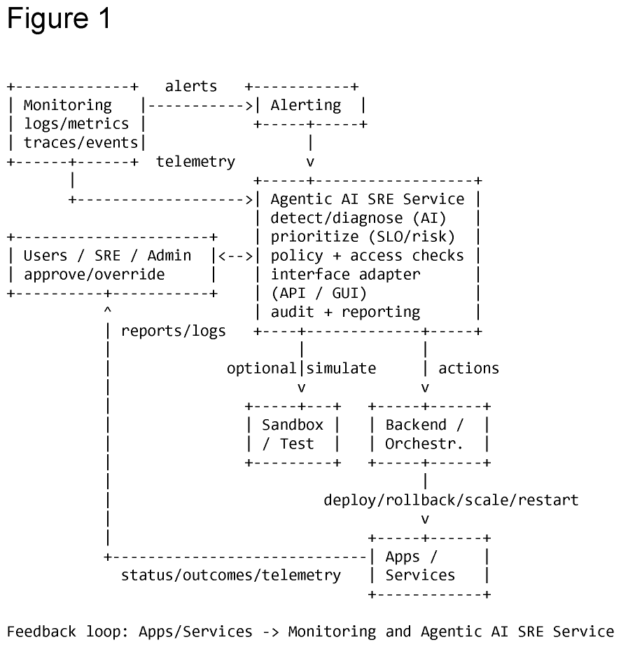

In FIG. 1, example labels may include:
LLM=large language model,
CV=computer vision, and
PR=pull request.

1. A computer-implemented method for site reliability engineering in a production computing environment, the method comprising:
a. monitoring, by one or more processors executing an autonomous site reliability engineering agent, telemetry data associated with one or more software applications in the production computing environment to detect an anomaly condition or performance issue;
b. analyzing, by the autonomous site reliability engineering agent, the telemetry data using one or more artificial intelligence models to diagnose a system issue including one or more of a failure, throttling condition, or bottleneck;
c. selecting, by the autonomous site reliability engineering agent, a corrective action from a set of candidate corrective actions based on the diagnosed system issue;
d. evaluating, by a policy evaluation engine executed by the one or more processors, whether execution of the corrective action is permitted under one or more access-control rules or security policies for the production computing environment;
e. responsive to determining that execution is permitted, executing the corrective action by interacting with at least one system interface comprising an application programming interface (API) or a graphical user interface (GUI), wherein the corrective action comprises one or more of scaling resources, initiating a deployment, initiating a rollback, performing garbage collection, or rebooting a system component; and
f. recording, by the one or more processors, an audit record identifying the detected anomaly condition or performance issue, the diagnosed system issue, and the executed corrective action.

2. The computer-implemented method of claim 1, wherein the autonomous site reliability engineering agent utilizes one or more machine learning models trained on historical system telemetry data and historical site reliability engineering actions to improve diagnostic accuracy or corrective-action selection over time.

3. The computer-implemented method of claim 1, wherein the policy evaluation engine is configured to verify that the corrective action complies with predefined access controls and security policies and to block execution of the corrective action when the corrective action is not authorized.

4. The computer-implemented method of claim 1, wherein the autonomous site reliability engineering agent operates continuously and prioritizes detected anomaly conditions or performance issues based on real-time system criticality and predefined service level objectives (SLOs).

5. The computer-implemented method of claim 1, further comprising generating a human-readable report describing actions taken by the autonomous site reliability engineering agent and a resulting system status update for operator oversight.

6. The computer-implemented method of claim 1, further comprising, prior to executing the corrective action in the production computing environment, simulating the corrective action in a sandbox environment to assess a potential impact of the corrective action, and executing the corrective action in the production computing environment based at least in part on a result of the simulating.
